(19) United States
(12) Patent Application Publication
(10) Pub. No.: US 2009/0071061 A1
(43) Pub. Date: Mar. 19, 2009

(54) Method and device for fumigating products in an enclosed space

(76) Inventors: Eddy Williame, Wilrijk (BE); Peter Boodts, Muizen (BE)

Correspondence Address: BACON & THOMAS, PLLC, 625 SLATERS LANE, FOURTH FLOOR, ALEXANDRIA, VA, 22314-1176, US

(21) Appl. No.: 11/886,968

(22) PCT Filed: Mar. 16, 2006
(86) PCT No.: PCT/BE2006/000018

§ 371 Date: Sep. 24, 2007

(30) Foreign Application Priority Data
Mar. 24, 2005 (BE) BE 2005/0158
Sep. 2, 2005 (BE) BE 2005/0420

(51) Int. Cl. A01M 13/00

(52) U.S. Cl. 43/125; 43/124

(57) ABSTRACT

Method for fumigating products (2) in an enclosed space (4), which consists in making the air in this space (4) circulate in a closed circuit through at least one flow-through module (13, 38-42) with adsorption material (15) in which treatment gas has been adsorbed; in activating means (16) which release the treatment gas from the adsorption material (15) until a sufficient quantity of treatment gas has been blown in the enclosed space (4); in switching off the means (16); and, as soon as the products (2) have been sufficiently fumigated, in recycling the treatment gas again by making the mixture of air/treatment gas circulate via the flow-through modules (13, 38-42) in order to have the treatment gas adsorbed in the adsorption material (15).

The present invention concerns a method and a device for fumigating products in an enclosed space.

It is known that fumigation, in other words treating products by exposing them to a gas or vapour for a certain while, is often applied in the shipping trade to prevent loads from being damaged by insects and other vermin present in the load or container. The fumigated load may vary strongly, from tobacco, wood and furniture to clothing and shoes.

A known technique consists in putting tablets of aluminium or magnesium phosphite in the load that spread the highly toxic phosphoretted hydrogen gas. According to another technique, the toxic methyl bromide is spread in the load by means of a vaporizer. Also other treatment gasses or vapours are used, such as formaldehyde, sulphur fluoride, ammonia, hydrocyanic acid, etc.

After the gas or vapour has been applied in the containers or over a bulk load, degassing usually takes place by letting the treatment gas or treatment vapour escape in the open air, for example by opening the doors or hatches of the space in which the products to be treated are situated. Often, there is even no degassing at all.

A disadvantage of these known techniques is that the used gasses or vapours are usually highly toxic and are discharged in the environment, which is harmful. Thus, it is known that methyl bromide may affect the ozone layer.

Another disadvantage is that, while degassing, the treatment gas or the treatment vapour is lost, such that it cannot be used again for a subsequent fumigation.

An additional disadvantage is that by applying an insufficient or a wrong degassing or no degassing at all, toxic or harmful gasses or vapours stay behind in the enclosed treatment space, thus endangering the health of the people who have to enter these spaces, such as for example dockworkers who have to transfer or unload the fumigated products or customs officers, as well as people living in the neighborhood of the harbour or even the consumer who obtains a product whose packaging still contains for example treatment gas or treatment vapour.

The present invention aims to remedy one or several of the above-mentioned and other disadvantages.

To this end, the present invention concerns a method for fumigating products in an enclosed space, which consists in making the air in this space circulate in a closed circuit through at least one flow-through module which is provided with adsorption means, in which a quantity of treatment gas or vapour is adsorbed; the activation of means which make it possible to release the treatment gas or the treatment vapour from the adsorption means while the air is circulating, until a sufficient quantity of treatment gas or vapour has been blown in the enclosed space, after which the above-mentioned means are deactivated, and as soon as the products have been fumigated sufficiently, the released treatment gas or the released treatment vapour is recycled again by drawing the mixture of air/treatment gas or air/treatment vapour out of the space and by making it circulate through the flow-through modules in order to make sure that the treatment gas or the treatment vapour is adsorbed in the adsorption means.

An advantage of such a method for fumigating products in an enclosed space according to the present invention is that the treatment gas or the treatment vapour does not end up in the open air, such that there is no environmental damage and, for example, affection of the ozone layer is avoided on the one hand, and the risk for personnel handling the goods or possible third persons is considerably reduced on the other hand.

Another advantage of this method is that the treatment gas or the treatment vapour is recycled in the flow-through modules, as a result of which these flow-through modules can be re-used to, for example, fumigate a subsequent load of products or to be able to easily discharge the recycled treatment gas or the recycled treatment vapour in the flow-through modules so as to destroy it.

To this end, such flow-through modules are preferably made such that they are easy to seal and to convey.

An additional advantage is that when recycling the treatment gas or the treatment vapour by means of the forced circulation of the mixture of air/treatment gas or air/treatment vapour over the adsorption means, a better degassing is obtained than with the known techniques, thus reducing the risk of persons getting into contact with the hazardous treatment gas or the hazardous treatment vapour.

Use is preferably made of several flow-through modules, whereby, during the fumigation, the air is successively sent through one or several of the flow-through modules on the one hand, while the other modules are sealed, each time until a sufficient quantity of treatment gas or vapour has been released from the flow-through modules concerned or until a sufficient quantity of treatment gas or vapour is present in the space and, while recycling the treatment gas or the treatment vapour on the other hand, the gas mixture which has been drawn out of the space is successively sent through one or several of the flow-through modules, while the other modules are sealed, each time until a sufficient quantity of treatment gas or vapour has been drawn out of the space or a sufficient quantity of treatment gas or vapour has been stored in the flow-through modules.

An advantage of such a method with several flow-through modules is that less adsorption means are required, since a better use is made of it, for the following reasons.

The quantity of treatment gas or vapour which can be adsorbed, for example during the recycling in the adsorption means, depends on to what degree the adsorption means have been saturated by the treatment gas or vapour, on the degree of saturation of the mixture of air and treatment gas or vapour flowing through the flow-through module, and on the difference between both degrees of saturation.

When recycling treatment gas or vapour from the mixture of air/treatment gas or air/treatment vapour by means of a single flow-through module, after a certain while, when an insufficient number of adsorption means are used, the degree of saturation of the adsorption means will have increased and the degree of saturation of the mixture of air/treatment gas or air/treatment vapour will have decreased to a point where the difference between both degrees of saturation is insufficient for treatment gas or vapour to be further adsorbed in the adsorption means.

In order to nevertheless obtain a good recycling of the treatment gas or vapour, one has to avoid that the degree of saturation of the adsorption means becomes too high and thus a very large number of adsorption means will have to be used.

By making use of several flow-through modules, in case of saturation of a first flow-through module, it is possible to place a new flow-through module in the mixture of air/treatment gas or air/treatment vapour flowing through, in which new module no treatment gas or vapour has been adsorbed in the adsorption means so far, such that treatment gas or vapour can be adsorbed from the mixture of air/treatment gas or air/treatment vapour again.

Naturally, the same goes for the release of treatment gas or vapour from the adsorption means, but the other way round.

In other words, this method makes it possible to use considerably less adsorption means, which also implies an energy saving.

Indeed, in order to release or recycle the treatment gas or the treatment vapour, the adsorption means is preferably heated or cooled respectively, whereby pulsated forced ventilation is preferably applied as well for the release.

Such pulsated forced ventilation consists in removing the released treatment gas or the released treatment vapour from the flow-through module during the heating phase of the adsorption means by means of a series of short ventilation pulses whereby each pulse is each time followed by a long period without any ventilation. Thus, the generated heat is optimally used for the release of the treatment gas or the treatment vapour from the adsorption means, after which a short ventilation pulse suffices to remove released treatment gas or vapour from the flow-through module.

This method is advantageous in that a considerable saving can be realised on the energy required for heating up the adsorption means, and in that the process for the release of treatment gas or vapour can be speeded up.

The invention also concerns a device for fumigating products in an enclosed space according to a method as described above, whereby this device mainly consists of a ventilation or exhaust device with a suction pipe and an outlet pipe which can be connected to the above-mentioned space and whereby at least one flow-through module is provided in one of both pipes in the shape of a container filled with adsorption means which make it possible to adsorb treatment gas or vapour and whereby this flow-through module is provided with means which make it possible, when activated, to release the adsorbed treatment gas or the adsorbed treatment vapour again.

The adsorption means preferably consist of active carbon or zeolites, and the treatment gas contained therein, for example methyl bromide, or the treatment vapour contained therein is released again through sufficient heating of the adsorption means, for example by heating the adsorption means up to 160° C. by means of a heating strip and a heat distributor provided in or around the container.

The other way round, the flow-through modules are preferably provided with a cooling element as well with which the adsorption means can be cooled during the recycling of the treatment gas or the treatment vapour, which promotes the adsorption of treatment gas or vapour from the mixture of air/treatment gas or air/treatment vapour and which influences the general consumption of energy.

Additionally, the flow-through modules are preferably also made heat-insulating and they are provided with heat-conducting parts to guide the heat, dissipated by the above-mentioned heating element or absorbed by the above-mentioned cooling element respectively to the adsorption means or to discharge it there from.

This implies another restriction of the energy consumption.

Moreover, the release of the treatment gas or the treatment vapour can be made more efficient by providing a device according to the invention with a ventilation or exhaust device which can work in a pulsating manner, for example by providing a membrane pump which is preferably made with a double membrane and which is provided with a leak detector.

As already mentioned, this embodiment allows for a faster operation and it has an energy-saving effect.

In order to better explain the characteristics of the invention, the following preferred embodiment is given as an example only without being limitative in any way, with reference to the accompanying drawings, in which:

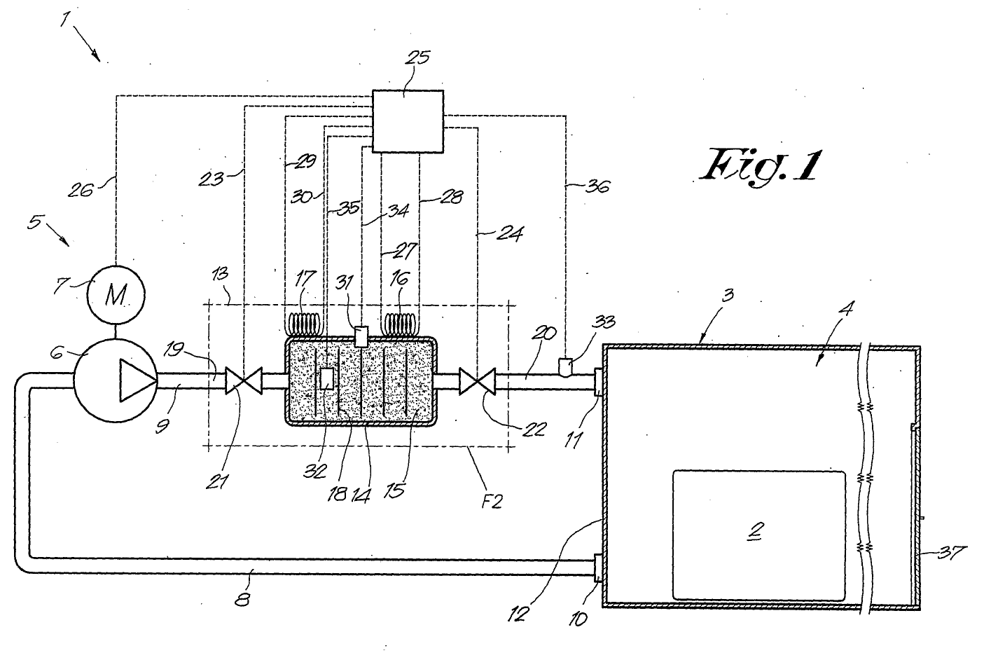

FIG. 1 schematically represents a device for fumigating products according to the invention which is connected to a space in which the products to be fumigated are situated;

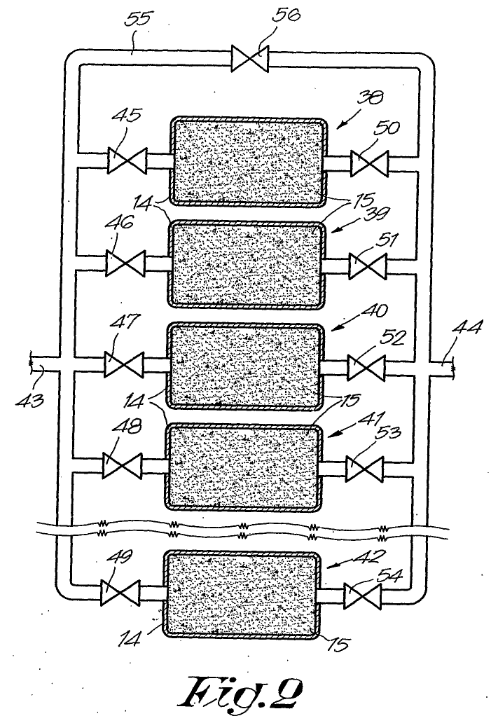

FIG. 2 represents a variant of the part indicated by F2 in FIG. 1.

The device 1 for fumigating products 2 in a shed 3 or the like confining an enclosed space 4 as represented in FIG. 1 mainly consists of a ventilation or exhaust device 5, in this case a fan 6 driven by an electric motor 7, with a suction pipe 8 and an outlet pipe 9 which is connected to the enclosed space 4, via the passages 10 and 11 respectively in the wall 12 of the shed 3.

In the outlet pipe 9 is provided a flow-through module 13 in the shape of a container 14 filled with adsorption means 15 which make it possible to adsorb a treatment gas or vapour.

The container 14 is preferably made heat-insulating.

In view of the adsorption of the treatment gas or the treatment vapour, which may be for example methyl bromide gas, the adsorption means 15 may consist of active carbon or zeolites.

Further, the flow-through module 13 is provided with a heating element 16 with which the adsorption means 15 can be heated up to a temperature at which the treatment gas or the treatment vapour, which has been adsorbed in the adsorption means 15, is released again.

In case the adsorption means consist of active carbon for the adsorption of the methyl bromide treatment gas, the capacity of the heating element 16 is preferably selected such that the active carbon can be heated up to a temperature of some 160° C. so as to release the methyl bromide gas again.

The flow-through module 13 is also provided with a cooling element 17 with which the adsorption means 15 can be cooled so as to promote the recycling of the treatment gas or the treatment vapour in the adsorption means after fumigation.

In order to obtain a sufficient conduction of the heat coming from the heating element 16 to the adsorption means 15 or a sufficient heat dissipation from the adsorption means 15 to the above-mentioned cooling element 17, the flow-through module 13 is preferably equipped with heat-conducting parts 18.

The inlet 19 and the outlet 20 of the flow-through module 13 can be sealed by an inlet valve 21 and an outlet valve 22 respectively, which in this case are electro valves that are connected via the electric conductors 23 en 24 respectively to a control unit 25 which makes it possible to automatically open and close the valves 21 and 22.

The electric motor 7, the heating element 16 and the cooling element 17 can also be controlled by the control unit 25, via conductors 26, 27-28 and 29-30 respectively.

The flow-through module 13 is also equipped with a temperature probe 31 and a probe 32 which measures the degree of saturation of the adsorption means 15.

Further, another probe 33 can be provided at the height of the passage 11 where the outlet pipe 9 is connected to the enclosed space 4, with which probe the concentration of the treatment gas or of the treatment vapour in the enclosed space 4 can be measured.

The probes 31, 32 and 33 each transmit a signal, via conductors 34, 35 and 36 respectively, to the control unit 25. This control unit 25 is provided with an algorithm which makes it possible to control the valves 21 and 22 of the flow-through module 13, as well as the electric motor 7, the heating element 16 and the cooling element 17, as a function of the signals obtained from the probes 31, 32 and 33.

In order to fumigate products 2 provided in a shed 3 according to a method of the present invention, the device 1 according to the invention is first connected via the passages 10 and 11.

The device 1 which is being connected contains a certain quantity of treatment gas or vapour which is adsorbed in the adsorption means 15 of the flow-through module 13.

If necessary, a maximum quantity of treatment gas or vapour can be stored, corresponding to the absolute saturation of the adsorption means 15 of the flow-through module 13.

The inlet valve 21 as well as the outlet valve 22 are initially kept closed by the control unit 25, whereas the heating element 16 and the electric motor 7 are switched off.

When personnel is no longer present in the shed 3 and the shed 3 is hermetically sealed as well as possible by closing all doors 37, hatches and the like, the control unit 25 activates the heating element 16, as a result of which the adsorption means 15 are heated.

The temperature probe 31 measures the temperature of the adsorption means 15 and, as soon as the temperature is sufficiently high, such that the treatment gas or the treatment vapour can be released by the adsorption means, valves 21 and 22 are opened by the control unit and the electric motor 7 is started in order to drive the fan 6.

The fan 6 draws the air out of the shed 3 via the suction pipe 3 and carries it back to the shed 3 via the outlet pipe 9 and through the adsorption means 15 of the flow-through module 13.

The treatment gas or the treatment vapour which is released during the heating will hereby be mixed with the circulating air. This mixture is blown in all directions by the ventilation or suction system 5, as a result of which the shed 3 is filled with a mixture of air and treatment gas or vapour, such that the products 2 to be treated are exposed to the effects of the treatment gas or the treatment vapour in the space 4.

In order to improve the efficiency at the time of release of the treatment gas or the treatment vapour from the adsorption means 15, it is advisable to control the ventilation or exhaust device 5 in a pulsating manner instead of ventilating constantly.

This can be realised for example by making use of a membrane pump in the place of a fan 6.

Thanks to the pulsating operation of the membrane pump there will be no or practically no ventilation through the adsorption means 15 during a certain period, such that, during this period, the heat supply through the heating element 16 is not counteracted by any ventilation, so that less energy is lost.

When the membrane pump then drives a forced ventilation pulse through the adsorption means 15 after this period, in view of the fumigation, treatment gas or vapour released from the adsorption means 15 by means of heating is then driven out of the flow-through module 13.

Such a membrane pump is preferably made with a double membrane which is provided with a leak detector.

This embodiment guarantees extra protection, whereby a leak in one of the membranes does not necessarily mean that treatment gas or vapour can escape, whereas the leak detector can transmit a signal so as to warn an operator.

Further, use is preferably made of a high-pressure membrane pump, such that a compact device 1 is obtained and a sufficient delivery can be nevertheless provided for.

The pressure which is obtained with such high-pressure membrane pumps must not be exaggerated, however, and it amounts to some 1 bar.

Probes 32 and 33 measure the quantity of treatment gas or vapour present in the adsorption means 15 and the shed 3 respectively. By processing the signals of these probes 32 and 33, the control unit 25 can check whether a sufficient quantity of treatment gas or vapour has been released by the adsorption means 15 and whether the concentration of the treatment gas or the treatment vapour in the shed 3 is sufficiently high, and if so the control unit 25 will switch off the heating element 16, it will close the valves 21 and 22 and it will possibly stop the fan 6.

As soon as the products 2 have been fumigated during a sufficient length of time and at sufficiently high concentrations, the treatment is stopped and, according to the invention, the treatment gas or the treatment vapour is recycled again in the adsorption means 15 according to the method described hereafter.

The control unit 25 switches on the cooling element 17, such that the adsorption means 15 can cool down to a temperature at which the treatment gas or the treatment vapour is adsorbed instead of being released.

The ventilation or suction device 6 blows the mixture of air/treatment gas or air/treatment vapour in all directions, as a result of which, while this mixture goes through the adsorption means 15 in the flow-through module 13, more and more treatment gas or vapour is adsorbed in the adsorption means 15 again.

The signals coming from the probes 32 and 33 are compared this time with pre-set reference values by means of another processing operation in the control unit 25, whereby the degree of saturation of the adsorption means 15 is reached and the concentration of treatment gas or vapour in the shed 3 is sufficiently low, so that people can be admitted safely in the enclosed space 4.

When the air in the shed 3 is sufficiently clean again as the treatment gas or the treatment vapour has been entirely or practically entirely recycled, the electric motor 7 is stopped by the control unit 25, the cooling element 17 is switched off and the valves 21 and 22 respectively at the inlet 19 and at the outlet 20 of the flow-through module 13 are closed.

The doors 37 of the shed 3 can now be opened again and the device 1 can be removed from the shed 3 by disconnecting the suction pipe 3 and the outlet pipe 9 at the height of passages 10 and 11.

It is clear that with this method according to the invention, the treatment gas or the treatment vapour can be entirely recycled in the flow-through modules 13, and that no treatment gas or treatment vapour is distributed in the open air.

It is also clear that a subsequent fumigation can be carried out with the same treatment gas or the same treatment vapour by connecting the device 1 to a shed 3 again.

The flow-through module 13 can also be provided with appropriate couplings which make it possible to disconnect the flow-through module 13 in a simple manner, for example so as to have the treatment gas or the treatment vapour destroyed or replaced by specialised firms.

Although a device 1 has been described above which can be disconnected from the shed 3 or the like, so as to be able to move the device 1 from one location to another, it is not excluded for this device 1 to be connected to a shed 3 concerned or the like in a fixed manner.

In view of the mobility of the device, the dimensions of the flow-through modules 13 can be best restricted such that, when large quantities of the treatment gas or the treatment vapour are required, the flow-through module 13 can be best replaced by a series of flow-through modules which are connected to each other, as is represented in FIG. 2.

FIG. 2 shows such an arrangement whereby a series of flow-through modules 38 to 42, similar to the flow-through module 13 as described above, are connected to each other by means of a common inlet collector 43 and an outlet collector 44.

Each of the above-mentioned flow-through modules 38 to 42 is provided with an inlet valve 45 to 49 and an outlet valve 50 to 54, and if need be with a heating element, a cooling element and one or several probes which are not represented in this FIG. 2 for clarity's sake.

In the given example of FIG. 2, if necessary, the flow-through modules 38 to 42 may be bridged by means of a bypass 55 connecting the inlet collector 43 to the outlet collector 44 and which is provided with a stop valve 56.

In order to fumigate products 2 or to recycle treatment gas or vapour after the fumigation according to a method of the invention by means of a device 1 made as represented in FIG. 2, the operation is similar to the one described above.

The sole difference is that the flow-through modules 38 to 42 can be controlled in such a manner by the control unit 25 that they are successively being flown through by the circulating air or the mixture of air and treatment gas or vapour, one after the other or in groups of several flow-through modules.

To this end, for example during the fumigation by the control unit 25, the heating element of a first flow-through module 38 is activated first, such that the temperature of the adsorption means 15 concerned rises sufficiently so as to release treatment gas or vapour, after which the valves 45 and 50 of this flow-through module 38 are opened, whereas the other valves 46 to 49, 51 to 54 and 56 remain closed and the electric motor 7 is started.

As soon as all the gas has been released from the first flow-through module 38, the electric motor 7 is shut down, the heating element of the flow-through module 38 is disconnected and the valves 45 and 50 are closed, after which a subsequent flow-through module, for example the flow-through module 39, is heated to a temperature at which treatment gas or vapour stored in the flow-through module 39 is released.

Once the required temperature has been reached, the control unit 25 opens the valves 46 and 51 of the flow-through module 39 and it starts the electric motor 7 again. The gas mixture will thus circulate through the flow-through module 39 and additional treatment gas or vapour will be adsorbed in the gas mixture.

Alternatively, in order to avoid that the motor 7 needs to be shut down, use can be made of the above-mentioned bypass 55 which is temporarily opened by means of the stop valve 36 when switching from one flow-through module 33 to the next flow-through module 39.

In this manner, all or several of the flow-through modules 38 to 42 can be opened until the concentration of the treatment gas or the treatment vapour in the space 4 has reached the required level.

In an analogous manner, but the other way round, the released treatment gas or the released treatment vapour can be recycled again by drawing in the mixture from the space 4 and by letting it subsequently flow through one or several of the possibly cooled flow-through modules 38 to 42.

An additional advantage of the use of several flow-through modules is that the capacity of each flow-through module can be optimally used, knowing that the efficiency of the release of the treatment gas or the treatment vapour, or the recycling thereof, strongly depends on the degree of saturation of the gas mixture, the degree of saturation of the adsorption means 15 and the difference between both.

It is clear that, depending on the required degree of automation, the device may be equipped with additional probes and meters which make it possible to control the valves by means of an appropriate algorithm which has been stored in the control unit and which allows for a control as a function of one or several parameters from the following group:
the temperature in the flow-through modules 13, 38 to 42;
the saturation degree of the adsorption means 15 in the flow-through modules 13, 38 to 42;
the temperature in the space 4;
the concentration of treatment gas or vapour in the space 4;
the flow rate through the pipes 8 and 9 of the ventilation or exhaust device 5; and
the leak flow to the open air.

The invention is by no means restricted to the embodiments given as an example and represented in the accompanying drawings; on the contrary, such a device for fumigating products in an enclosed space can be made in different shapes and dimensions while still remaining within the scope of the invention. Also the method according to the invention as described above can be applied in other ways.

1-23. (canceled)

24. Method for fumigating products in an enclosed space, comprising the steps:
making the air in the space circulate in a closed circuit through several flow-through modules which are provided with adsorption material in which a quantity of treatment gas or vapour has been adsorbed;
activating a gas release arrangement enabling release of the treatment gas or the treatment vapour from the adsorption material while the air is circulating, until a sufficient quantity of the treatment gas or vapour has been blown in the enclosed space;
then switching off the gas release arrangement;
after fumigation is completed, recycling the released treatment gas or the released treatment vapour by drawing the mixture of the air/treatment gas or air/treatment vapour from the space and letting it circulate via the flow-through modules so the treatment gas or the treatment vapour is adsorbed in the adsorption material;
during fumigation, sending the air successively through one or several of the flow-through modules, while the other modules are sealed, until a sufficient quantity of treatment gas or vapour has been released from the flow-through modules or until a sufficient quantity of treatment gas or vapour is present in the space; and
while recycling the treatment gas or the treatment vapour, successively sending the gas mixture drawn in from the space through one or several of the flow-through modules, while other modules are sealed, until a sufficient quantity of treatment gas or vapour has been drawn from the space or until a sufficient quantity of treatment gas or vapour has been stored in the flow-through modules.

25. Method according to claim 24, wherein, in order to release the treatment gas or the treatment vapour, the adsorption material is heated by activating a heating element.

26. Method according to claim 24, wherein, in order to recycle the treatment gas or the treatment vapour, the adsorption material is cooled by activating a cooling element.

27. Method according to claim 25, wherein in order to release the treatment gas or the treatment vapour from the adsorption material, pulsated forced ventilation is applied.

28. Method according to claim 24, wherein, for the fumigation, methyl bromide is used as a treatment gas, adsorbed in active carbon which is used as adsorption material.

29. Device for fumigating products in an enclosed space according to the method of claim 24, comprising a ventilation or exhaust device with a suction pipe and an outlet pipe which is connectable to the space; wherein, in one of both pipes at least one flow-through module is provided in the form of a container which is filled with adsorption material which enables adsorption of treatment gas or vapour; the flow-through module being provided with a gas release arrangement which, when activated, enables release of the adsorbed treatment gas or the adsorbed treatment vapour again.

30. Device according to claim 29, wherein said adsorption material comprises active carbon or zeolites.

31. Device according to claim 29, wherein the treatment gas is methyl bromide.

32. Device according to claim 29, wherein the gas release arrangement includes a heating element.

33. Device according to claim 32, wherein the heating element is capable of heating the adsorption material to at least 120° C.

34. Device according to claim 29, including a flow-through module having a cooling element.

35. Device according to claim 32, including a flow-through module having heat-conducting parts arranged to distribute heat dissipated by the heating element or absorbed by the cooling element, respectively, over the adsorption material or to remove it therefrom.

36. Device according to claim 32, including a flow-through module that is heat-insulating.

37. Device according to claim 29, wherein the ventilation or exhaust device is operable in a pulsating manner.

38. Device according to claim 37, wherein the ventilation or exhaust device comprises a membrane pump.

39. Device according to claim 38, wherein the membrane pump comprises a double membrane and includes a leak detector.

40. Device according to claim 29, wherein the inlet and the outlet of each flow-through module is sealable by an inlet valve and an outlet valve, respectively.

41. Device according to claim 29, wherein several flow-through modules are provided in the suction pipe or outlet pipe.

42. Device according to claim 41, wherein the flow-through modules are connected to the suction pipe or the outlet pipe via a common inlet collector and a common outlet collector.

43. Device according to claim 40, wherein the valves are controllable and including a control unit arranged to control the valves.

44. Device according to claim 43, wherein the control unit is arranged such that the inlet and outlet valves of one or several of the flow-through modules may be opened simultaneously, while the inlet and outlet valves of the other flow-through modules are closed.

45. Device according to claim 44, wherein the control unit is arranged so that the inlet and outlet valves of the flow-through modules are sequentially controllable, such that the flow-through modules are blown through successively.

46. Device according to claim 43, wherein the control unit includes an algorithm enabling control of the valves as a function of the signal of one or several probes which enables determination of one or several of the following parameters:
the temperature in the flow-through modules;
the degree of saturation of the adsorption apparatus in the flow-through modules;
the temperature in the space;
the concentration of treatment gas or vapour in the space;
the flow rate through the pipes of the ventilation or exhaust device; and
the leak flow to the open air.
